(19) United States
(12) Patent Application Publication
(10) Pub. No.: US 2004/0149199 A1
(43) Pub. Date: Aug. 5, 2004

(54) Marking systems, methods and apparatuses

(75) Inventors: Mark Frank, Austin, TX (US); Fred Paul, Georgetown, TX (US); Evan Haynes, Austin, TX (US)

Correspondence Address: FULBRIGHT & JAWORSKI L.L.P., 600 CONGRESS AVE., SUITE 2400, AUSTIN, TX, 78701, US

(73) Assignee: BAE SYSTEMS Integrated Defense Solutions Inc.

(21) Appl. No.: 10/345,065

(22) Filed: Jan. 15, 2003

(51) Int. Cl. G08B 21/00

(52) U.S. Cl. 116/100

(57) ABSTRACT

Systems, methods, and apparatuses for marking a substrate. In a representative embodiment, the invention involves a marking system including a marker container, a marker cutter, and a marker driver. The marker container is configured to contain marker material having flexible shaft material. The marker cutter is coupled to the marker container, and the marker driver is coupled to the marker cutter.

### BACKGROUND OF THE INVENTION

1. Field of the Invention

The invention relates generally to the field of land marking. More particularly, the invention relates to systems, methods, and apparatuses that involve driving a flexible marker into a substrate, such as the ground.

2. Discussion of the Related Art

A number of industries find use in land marking systems including, for example, the construction and survey industry. The most common manner of employing a land marker is to simply set the marker on the ground. Hand-placed flag markers are typically pushed into the ground, or an insertion tool such as a screwdriver with a notched blade can be used to assist the installation of the marker into hard surfaces. Individual flags are commercially available and are packaged in small bundles, but it can be difficult and expensive to automate their installation.

Automated paint striping systems are the standard for marking the edges of roadways. However, paint may be undesirable in a number of applications because it provides no vertical dimension, severely limiting visibility. Continuously spooled marking tapes provide good surface area, but securing a marking tape to the ground can be a difficult task.

Land marking systems have important military applications. For example, such systems may be used for marking a lane that has been cleared of land mines. The Pathfinder is a military land marking system that shoots one-meter long poles into the ground at regular intervals. Shortcomings of this technology include its large physical size and weight, high power requirements, and the size and price of its markers and expendables. Thus, such a system is inappropriate in a number of applications including, for example, light vehicles moving over long distances.

Shortcomings described above are not intended to be exhaustive, but rather are among the many that tend to impair the effectiveness of previously known techniques of marking. Other noteworthy problems may also exist; however, those mentioned here are sufficient to demonstrate that methodologies appearing in the art have not been altogether satisfactory and that a need exists for the techniques described in this disclosure.

### SUMMARY

Techniques described in this disclosure are applicable to a vast number of marking applications, including but not limited to marking applications of the military such as marking lanes that have been cleared of land mines.

In one respect, the invention involves a marking system including a marker container, a marker cutter, and a marker driver. The marker container is configured to contain marker material having flexible shaft material. The marker cutter is coupled to the marker container, and the marker driver is coupled to the marker cutter.

In another respect, the invention involves a marking system including a frame, a marker container, an actuator, a marker feeder, a marker advancer, a marker cutter, and a marker driver. The marker container is coupled to the frame and is configured to contain marker material. The actuator is hinged to the frame at a first location. The marker feeder is hinged to the frame at a second location, and the marker feeder is hinged to the actuator at a third location. The marker advancer is coupled to the marker feeder. The marker cutter is coupled to the marker feeder. The marker driver is coupled to an end of the marker feeder.

In another respect, the invention involves a marking method. A vehicle is directed along a substrate, and the vehicle includes a marking system. A marker having a flexible shaft is inserted into the substrate using the marking system. The marker is bent during insertion such that a bent portion of the flexible shaft is implanted into the substrate.

In another respect, the invention involves an apparatus for marking a substrate including a wire, a plastic material, and a reflective substance. The plastic material is attached to the wire. The reflective substance is attached to at least a portion of the plastic material, and the reflective substance makes the plastic material more visible against a dark background than the plastic material would be without the reflective substance. The apparatus, or a section of the apparatus, is configured for implantation into the substrate.

In another respect, the invention involves a marking system including a marker holder, a marker driver, a marker ram, and a flexible coupling. The marker driver is in operative relation with the marker holder, and the marker driver includes the marker ram and the flexible coupling, which is coupled to the marker ram.

In another respect, the invention involves a marking system including a marker holder, a marker feeder, and a marker driving system. The marker feeder is in operative relation with the marker holder. The marker driving system is in operative relation with the marker feeder and includes an actuator and a marker ram that is coupled to the actuator by a flexible coupling.

These and other embodiments of the invention, along with associated advantages, will be better appreciated and understood when considered in conjunction with the following detailed description and the accompanying drawings.

### BRIEF DESCRIPTION OF THE DRAWINGS

The following drawings demonstrate certain aspects of the present invention. They illustrate by way of example and not limitation. The use of identical reference numerals does not necessarily indicate a an identical structure. Rather, the same reference numeral may be used to indicate a similar feature or a feature with similar functionality. Reference numeral designations should not be used to construe the claims.

FIG. 1 is a diagram of a marking system according to embodiments of this disclosure.

FIG. 2 is a side-view diagram of the marking system of FIG. 1, illustrating features such as a range of movement, according to embodiments of this disclosure.

FIG. 3 is a cross-section, side-view diagram of the marking system of FIG. 1 according to embodiments of this disclosure.

FIGS. 4A and 4B are cross-section diagrams of a portion of the marking system of FIG. 1, illustrating features such as the operation of a marker driver, according to embodiments of this disclosure.

FIGS. 5A and 5B are diagrams of a portion of the marking system of FIG. 1, illustrating features such as a marker cutter, according to embodiments of this disclosure.

FIG. 6 is a cross-section, side-view diagram of a portion of the marking system of FIG. 1, illustrating features such as the marker cutter of FIGS. 5A and 5B.

FIG. 7 is a diagram of two marking systems of FIG. 1 incorporated onto a vehicle.

FIGS. 8A and 8B are diagrams of other marking systems according to embodiments of this disclosure.

FIG. 9 is a diagram of the marking system of FIG. 8A incorporated onto a vehicle.

FIG. 10 is a diagram of another marking system according to embodiments of this disclosure.

FIG. 11 is a diagram of another marking system according to embodiments of this disclosure.

FIG. 12 is a diagram of another marking system according to embodiments of this disclosure.

FIGS. 13A and 13B are diagrams of a marker driver according to embodiments of this disclosure.

FIGS. 14A and 14B are diagrams of a system for forming one-sided marker material having a flexible shaft, according to embodiments of this disclosure.

FIG. 15 is a diagram of a system for forming two-sided marker material having a flexible shaft, according to embodiments of this disclosure.

### DESCRIPTION

Embodiments of the invention provide for a greatly improved ability to effectively mark a wide variety of substrates for a wide range of applications. Before embarking on a detailed description of various embodiments, an introductory description of a representative embodiment may provide context. In a representative but non-limiting embodiment, a marking system dispenses spooled, highly visible, flexible-wire-reinforced tape or ribbon. The marking system automatically cuts a length of this marker material and implants it into the ground to mark an area (for example, a lane cleared of land mines or a buried object). The marking system may be incorporated onto a vehicle such as a Mine Detection Vehicle (MDV) or an All Terrain Vehicle (ATV). The marking system may work with a wide variety of sensors that aid in its automation or that provide extra functionality. For instance, the system may work with sensors suitable to properly dispense a correct amount of marker material at appropriate intervals and properly generate or sense force associated with implanting the marker. The flexible-wire-reinforced tape or ribbon may be one or two-sided, and it may be assembled directly on the marking system or may be pre-formed.

A detailed description of other non-limiting exemplary embodiments, figure by figure where possible, will now follow.

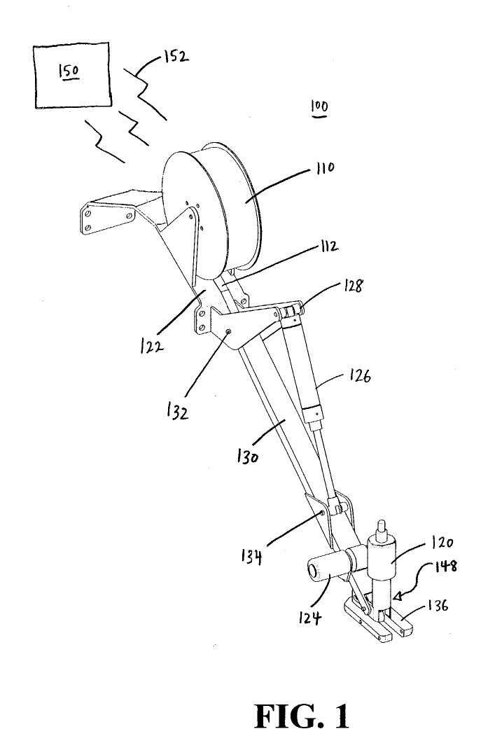

FIG. 1 is a diagram of a marking system 100 according to embodiments of this disclosure. Marking system 100 includes marker container 110, marker material 112, frame 122, marker driver 120, marker advancer 124, actuator 126, elongated marker feeder 130, foot 136, load sensor 148, control system 150 with associated signal 152, and hinge locations 128, 132 and 134.

Marker container 110 may be any structure suitable for holding and dispensing marker material 112. In the illustrated embodiment, marker container 110 is a spool around which marker material 112 can be wrapped. Such a spool may include circular side pieces, as shown. Marker container 110 may be sized as needed to accommodate a given amount of marker material 112. For example, if marking system 100 were to be used to mark a significant amount of terrain, a larger marker container 110 may be desirable. In one embodiment, marker container 110 is easily taken in and out of marking system 100 by simply snapping into or out of frame 122. Accordingly, marking system 100 may be readily re-loaded “on-the-fly” by simply replacing a spent marker container 110 with a fully loaded one. In one embodiment, this replacement process may be automated by, for example, sensing the amount of marker material 112 left on marker container 110 (via a weight measurement or other means) and utilizing a robotic arm or the like to remove the marker container 110 when a predetermined amount of marker material 112 has been spent and to replace it with a fully loaded marker container. In one embodiment, marker container 110 may include sensors that can monitor, for instance, the speed at which marker material 112 is being dispensed. In one embodiment, marker container 110 may include a motor (not shown) to assist or control the dispensing process. Such a motor may be controlled from a remote location such as a location within a vehicle.

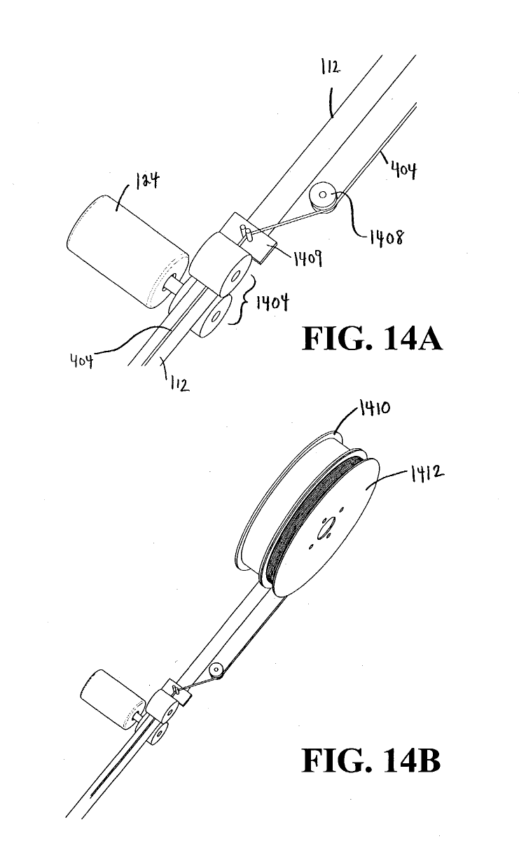

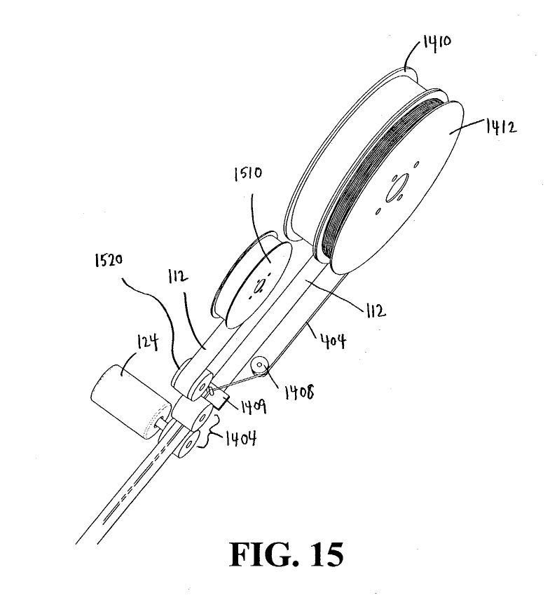

Marker material 112 may be any structure suitable for physically marking a location. In the illustrated embodiment, marker material 112 is a tape or ribbon that includes in or on its middle a flexible-wire that acts as a reinforcement. Marker material 112 is illustrated and explained in more detail in conjunction with FIGS. 14 and 15.

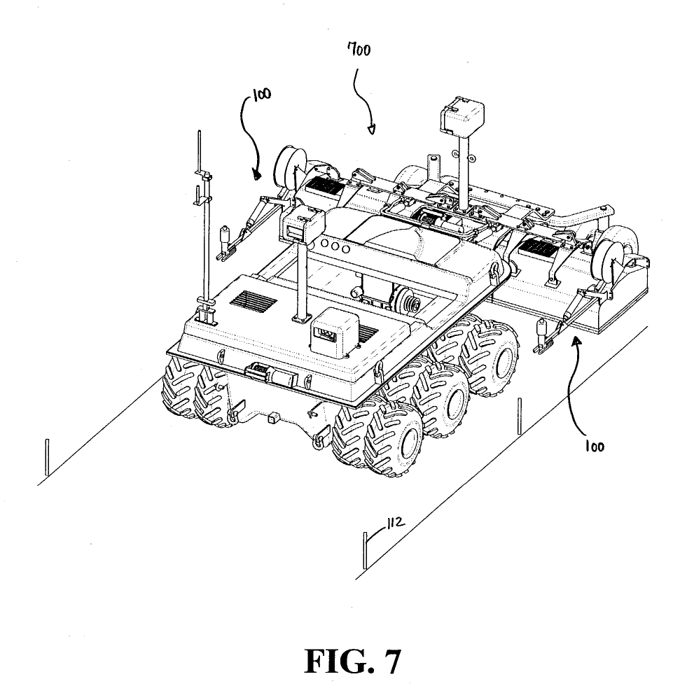

Frame 122 may be any structure suitable for providing stability and support to marking system 100. In the illustrated embodiment, frame 122 is a semi-curved structure attached to marker container 110 and to the lower assembly of marking system 100. Frame 122 may be readily attached to a vehicle (e.g. to a rear or a side portion), as illustrated in conjunction with FIG. 7. Frame 122 may be made from any material sufficiently strong to support and stabilize components of marking system 100. Depending on weight and strength considerations, one may choose from, for example, a variety of metals, alloys, or plastics known in the art.

Marker driver 120 may be any structure suitable for driving marker material 112 into a substrate such as the ground. In the illustrated embodiment, marker driver 120 includes a solenoid-driven member that operates to rapidly push marker material into the substrate. An exemplary marker driver is illustrated and described in conjunction with FIGS. 13A and 13B. In other embodiments, marker driver 120 may use a different mechanism to achieve the necessary force to drive marker material 112. For instance, one may use gravity, spring-released tension, pneumatic, or electrically-induced forces generated by devices known in the art.

Marker advancer 124 may be any structure suitable for dispensing and/or guiding marker material 112 to marker driver 120 for insertion into a substrate. In the illustrated embodiment, marker advancer 124 is a motorized roller wheel that operates to both dispense and guide marker material 112 from marker container 110 to marker driver 120. Marker advancer 124 may include, or be in operative relation with, one or more sensors that monitor the speed of advancement and/or the amount of marker material 112 that has been advanced. In one embodiment marker advancer 124 may be encoded to provide repeatable lengths of marker material 112 as determined by an operator or selected by software. The illustrated roller wheel may be made of soft urethane materials to minimize slippage at the marker advancer's drive motor.

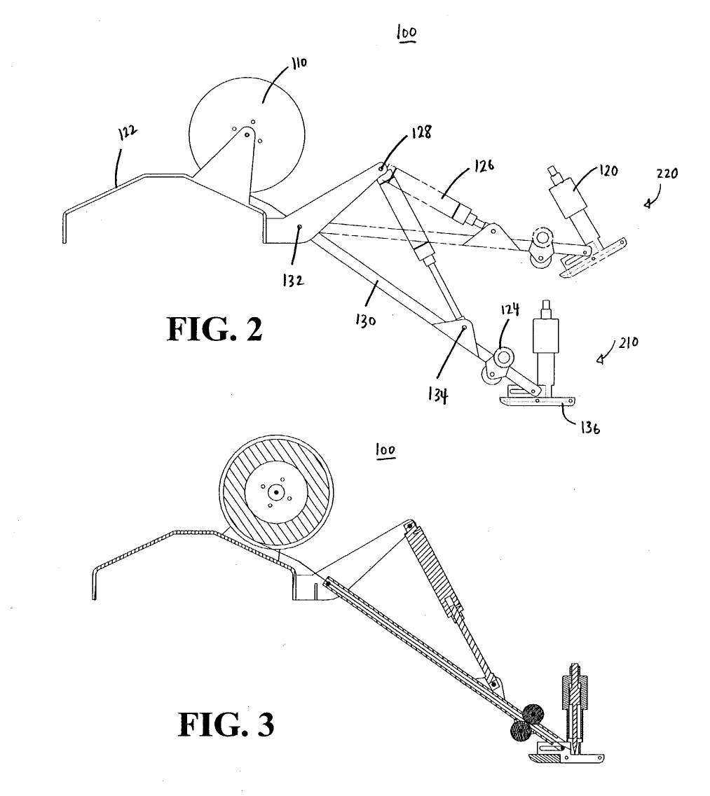

Actuator 126 may be any structure suitable for causing marker driver 120 to transition from a retracted position to an extended position (exemplary positions are illustrated and described in conjunction with FIG. 2). In the illustrated embodiment, actuator 126 is a pneumatic member attached to frame 122 and elongated marker feeder 130. When the pneumatic member retracts, marker driver 120 is drawn upwards into a retracted position. In such a position, marking system 100 is can be retracted out of the way of the substrate or objects on the substrate. If marking system 100 is incorporated onto a vehicle, actuator 126 allows the system to be retracted to avoid dragging along the ground, which may cause damage and may impair operation of the vehicle. When the pneumatic member extends, marker driver 120 is pushed outwards into an extended position. In such a position, marking system 100 is put into position to implant marker material 112 into a substrate. In the illustrated embodiment, foot 136 is placed on or near the substrate where marker driver 120 is able to properly drive and insert marker material 112.

Elongated marker feeder 130 may be any structure suitable for guiding and/or enclosing marker material 112. In the illustrated embodiment, elongated marker feeder 130 encloses and guides marker material 112 from marker container 110 to marker advancer 124. In other embodiments, elongated marker feeder 130 may be an open structure and may, in a simplified embodiment, simply be a pin or other mechanism to ensure the proper steering of marker material 112.

Foot 136 may be any structure suitable for planting, securing, orienting, or protecting marker driver 120. In the illustrated embodiment, foot 136 lies on or near a substrate, and marker driver 120 drives marker material into that substrate through the illustrated forked opening of foot 136. Foot 136 may be hinged to allow it to swivel and conform to the shape of different substrates.

Load sensor 148 may be any structure suitable for sensing a load associated with marking system 100. In the illustrated embodiment, load sensor 148 sends a signal in response to the marker driver 120 driving marker material 112 into a substrate. In response to this signal, control system 150 (discussed in more detail below) may activate actuator 126 to achieve a retracted position and/or may trigger the cutting of marker material 112. Load sensor 148 is shown generally as being housed in or near marker driver 120; however, it will be understood that the exact location may vary. Additionally, other load sensor may be utilized that, for example, sense when foot 136 contacts a substrate.

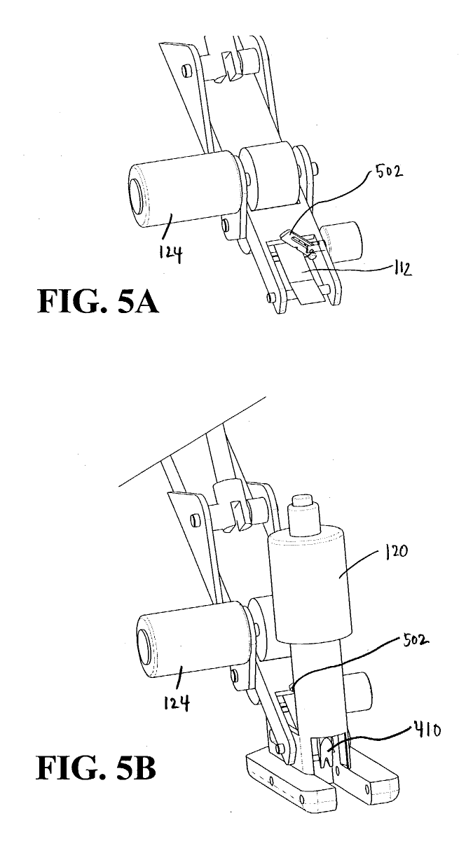

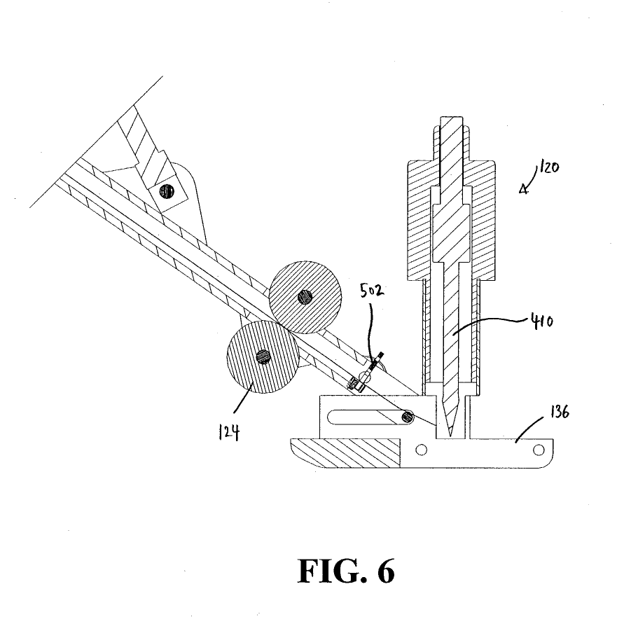

Control system 150 with associated signal 152 represents any computing device suitable for controlling the automation of one or more aspects of marking system 100. In the illustrated embodiment, control system 150 includes a central processing unit (CPU) or and/or microcontroller and memory loaded with firmware and/or software configured to monitor and operate components of marking system 100. In one embodiment, control system 150 receives signals from one or more sensors on marking system 100 such as a sensor associated with container 110, a sensor associated with marker advancer 124, and/or load sensor 148. Based on those signals, control system 150 may properly monitor and regulate the dispensing of marker material. Control system 150 also actively controls components by sending control signals. In one embodiment, control system 150 drives marker container 110 and/or marker advancer 124 in a regulated manner to dispense a predetermined amount of marker material 112. Further, control system 150 activates marker driver 120 at proper times to cut (discussed and illustrated in conjunction with FIGS. 5 and 6) and implant marker material 112. Still further, control system 150 activates actuator 126 so that marking system 100 assumes an extended or retracted position at appropriate times. In a representative embodiment, control system 100 (a) activates actuator 126 to achieve an extended position, (b) activates marker container 110 and/or marker advancer 124 to dispense a certain length of marker material 112, (c) activates a cutter to cut or knick that marker material 112 (see FIGS. 5 and 6 and associated discussion), (d) activates marker driver 120 to implant the marker material 112, and (e) activates actuator 126 to achieve a retracted position. Those of ordinary skill in the art will recognize that the monitoring and controlling of marking system 100 may utilize appropriate feedback routines and the like to ensure that the implantation process is efficient and reliably executed.

Signal 152 is illustrated as being a wireless signal. However, any media suitable for transmitting information suffices. For example, signals to and from control system 150 (and within marking system 100) may be wired, wireless, or any combination of the two. In one embodiment, control system 150 may interface with an on-board vehicle computer. This interface may be accomplished with RS-232 or a similar com-link to allow communication of command and control signals, allowing tracking of lane marker placements or the like. Marker material spacing may be dependent upon vehicle position feedback.

Hinge locations 128, 132 and 134 represent hinged connection points in the illustrated embodiment of FIG. 1. Actuator 126 couples to frame 122 at hinge location 128. Elongated marker feeder 130 couples to frame 122 and hinge location 132. Actuator 126 is coupled to elongated marker feeder 130 at hinged location 134. Those of ordinary skill in the art will recognize that connection points may vary as needed to achieve a desired form factor or the like.

FIG. 2 is a side-view diagram of the marking system 100 of FIG. 1, illustrating features such as a range of movement, according to embodiments of this disclosure. The description of various components and functionality given in conjunction with FIG. 1 apply for FIG. 2. FIG. 2 explicitly illustrates, however, an exemplary retracted position 220 and extended position 210. As can be seen, in extended position 210, foot 136 may be made to sit flat on, for instance, a substrate. In retracted position 220, marking system 100 may be moved out of the way so that, for example, it may be transported on a vehicle without impeding motion. As illustrated, extended position 210 is associated with an extended actuator 126 while retracted position 220 is associated with a retracted actuator 126.

FIG. 3 is a cross-section, side-view diagram of the marking system 100 of FIG. 1 according to embodiments of this disclosure. FIG. 3 is included to provide a cross-section view similar in arrangement to that of FIG. 2. The description of various components and functionality given in conjunction with FIGS. 1 and 2 apply for FIG. 3.

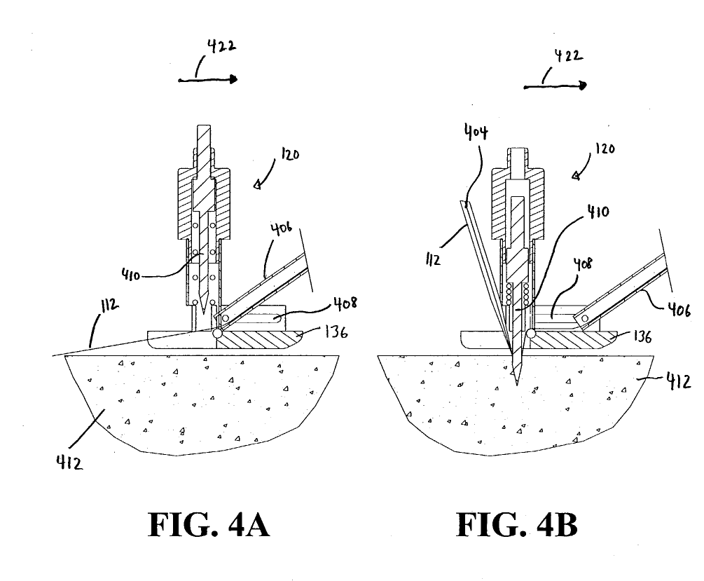

FIGS. 4A and 4B are cross-section diagrams of a portion of the marking system 100 of FIG. 1, illustrating features such as the operation of a marker driver 120, according to embodiments of this disclosure. In the illustrated embodiment, marker driver 120 includes drive member 410, which is the component that is thrust downward by force generated at marker driver 120 to implant marker material 112 into substrate 412. In FIG. 4A, drive member 410 is retracted, and a predetermined length of marker material 112 has been dispensed past and under marker driver 120. In FIG. 4B, drive member 410 is being thrust into an extended position, bending and implanting marker material 112 into substrate 412. Due at least in part to flexible shaft material 404 (which, in one embodiment may be a flexible reinforcing wire) in or on marker material 112, the marker material 112 may be configured to “stand up” following implantation, as illustrated. If marker material 112 is not flexible-wire-reinforced tape or ribbon reinforced in this, or a similar way, it is possible that the marker material 112 will simply lie on substrate 412 and go unnoticed. However, in certain embodiments, marker material 112 may be visible enough even in such a circumstance. In fact, in some embodiments, it may be preferred that marker material 112 lie more flat.

Arrow 422 in FIGS. 4A and 4B represent a direction of motion of marking system 110 (if, for example, it were mounted on a moving vehicle). In the illustrated embodiment, arm 406 and groove 408 advantageously allow foot 136 and marker driver 120 to remain fixed relative to substrate 412 for an extended period of time, despite motion of marking system 100. In particular, arm 406 slides within groove 408, “absorbing” the motion of marking system 100 so that marker driver 120 and foot 136 can remain fixed for a long enough time to execute the implantation process. A comparison of FIG. 4A with 4B illustrates this process. In FIG. 4A, foot 136 has just been deposited on or near substrate 412. Arm 408 is near the left-end of groove 408. All the while, the entire marking system 100 is moving in the direction of arrow 422. As the marking system 100 moves to the right, arm 406 is pulled in a sliding manner within groove 406. While arm 406 is sliding within groove 408, marker driver 120 and foot 136 remain fixed and implantation can take place without undue flexing caused by the motion of the marking system 100. When arm 406 has slid all the way within the groove (following the motion of marking system 100), marker driver 120 and foot 136 are finally pulled along also, and the process can repeat. By avoiding undue flexing, the implantation process may be made more reliable and consistent. Additionally, less wear-and-tear may be placed on the system.

FIGS. 5A and 5B are diagrams of a portion of the marking system of FIG. 1, illustrating features such as a marker cutter, according to embodiments of this disclosure. Marker cutter 502 (only a corner of which is visible in FIG. 5B) may be any structure suitable for cutting or notching marker material 112. In the illustrated embodiment, marker cutter 502 is a hinged cutting member. As illustrated, marker cutter 502 may include an indentation to accommodate flexible shaft material 404 within or on marker material 112. In embodiments in which marker cutter 502 simply notches marker material 112, the implantation process governed by marker driver 120 may complete the final cut of marker material. In other embodiments, marker cutter 502 completely cuts through marker material 112. The timing of the cutting or notching process may vary as desired. In one embodiment, marker material 112 may be cut prior to implantation. In another embodiment, cutting and implantation may be done simultaneously. In yet another embodiment, implantation may occur first, and then the marker material may be cut. As with other components of marking system 100, marker cutter 502 may be controlled via control system 150. Besides illustrating the edge of marker cutter 502, FIG. 5B also illustrates an embodiment of drive member 410 having a shape similar to a screwdriver with a notched blade. Such a shape may facilitate implantation.

FIG. 6 is a cross-section, side-view diagram of a portion of the marking system of FIG. 1, illustrating features such as the marker cutter of FIGS. 5A and 5B. FIG. 6 is included to provide a cross-section view of elements including marker cutter 502 introduced in FIG. 5. The description of various components and functionality given in conjunction with FIGS. 1-5 apply for FIG. 6.

FIG. 7 is a diagram of two marking systems of FIG. 1 incorporated onto a vehicle. Vehicle 700 may be of any type. In the illustrated embodiment, vehicle 700 is a Mine Detection Vehicle (MDV). A marking system 100 is illustrated as being on the left and right sides of vehicle 700. In one embodiment, connection of marking system 100 to vehicle 700 may be done via openings in frame 122. Appropriate fasteners may be inserted into those openings to attach marking system 100 to any portion of the vehicle such as the bumper or sides. Alternatively, marking system 100 may be made integral with vehicle 700, or it may be fastened in a way to allow for quick removal in case jettison of extra equipment is required. Accordingly, vehicle 700 may be used in a wide range of applications; for instance, a lane that has been cleared of land mines may be readily marked, as illustrated by the two rows of implanted marker materials 112. One having ordinary skill in the art will recognize numerous other applications of the marking arrangement of FIG. 7.

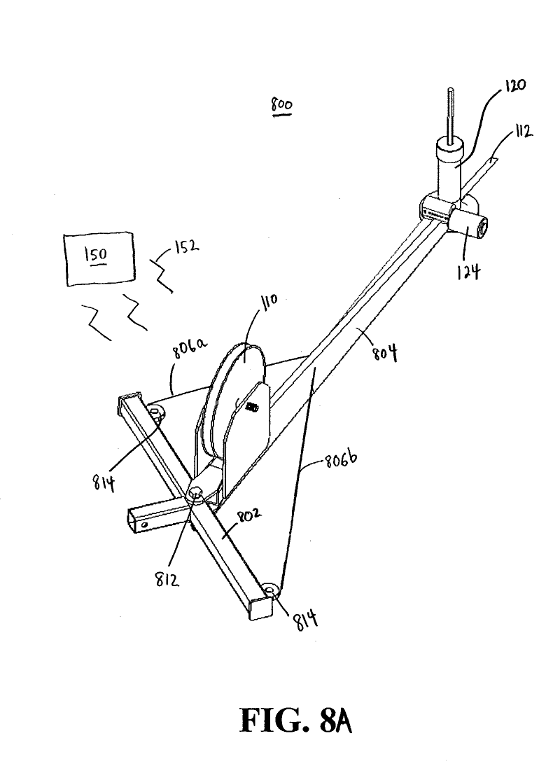

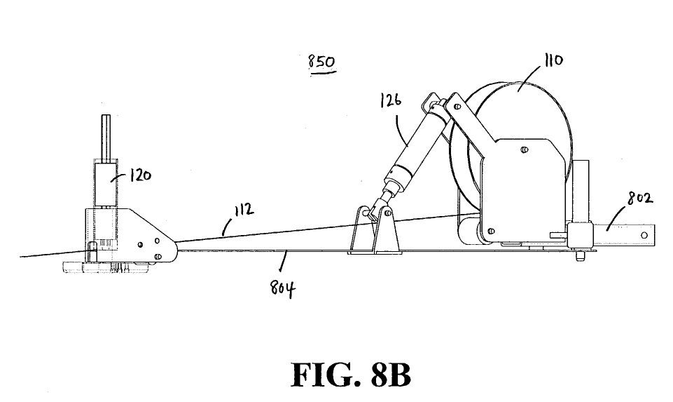

FIG. 8A is a diagram of a marking system 800 according to embodiments of this disclosure. Marking system 800 includes marker container 110, marker material 112, frame 802, marker driver 120, marker advancer 124, wire actuator 806, actuator wheel 814, elongated member 804, rotatable attachment 812, and control system 150 with associated signal 152. Marking system 800 may use the same or similar components described in relation to FIGS. 1-6 for marking system 100. Accordingly, the descriptions of marker container 110, marker material 112, marker driver 120, marker advancer 124, control system 150 with associated signal 152, and marker cutter 502 (which may be placed at or near marker cutter 120 as illustrated in FIGS. 5-6) will not be repeated.

Frame 802 may be any structure suitable for providing stability and support to marking system 800. In the illustrated embodiment, frame 802 is a straight, rigid structure rotatably attached to elongated member 804. Frame 802 may be made from any material sufficiently strong to support and stabilize components of marking system 800. Depending on weight and strength considerations, one may choose from, for example, a variety of metals, alloys, or plastics known in the art.

Because of rotatable attachment 812, elongated member 804 may be laterally displaced to different positions relative to frame 802. This, in turn, advantageously allows marker material 112 to be implanted in several different positions. In the illustrated embodiment, the displacement of elongated member 804 is governed by wire actuators 806. Wire actuator 806a may be lengthened or shortened relative to wire actuator 806b using actuator wheels 814 (the operation of which may be analogized to that of a wench) to lateral translation of elongated member 804. The rigidity of actuators 806 may be varied depending on need to achieve stability and accurate rotation. Those having ordinary skill in the art will recognize that other mechanisms may be used to achieve motion of elongated member 804 relative to frame 812.

Elongated member 804 may be any structure suitable for flexing or being translated upwards and downwards. In the illustrated embodiment, elongated member 804 includes a spring or spring-like material capable of storing potential energy when translated or flexed upwards. Thus, elongated member 804 may be flexed or translated upward, released, and then sprung downward to release sufficient energy at marker driver 120 to implant marker material 112. In effect, this action may be analogized to that of a hammer swinging downward (here, the elongated shaft 804 being analogous to a shaft of a hammer and marker driver 120 being analogous to the hammer head). In one embodiment, elongated member 804 may be flexed upward using a strap (not shown) or similar structure coupled to the underside of elongated member 804. That strap may be lifted using a wench or drive motor to achieve flexing. The amount of flexing may be measured with a linear encoder. When implantation is required, the strap may be released to rapidly spring elongated member 804 downward to implant marker material 112. In one embodiment, the potential energy alone of elongated member 804 may be enough to implant marker material 110; however, in other embodiments, marker driver 124 may assist with the implantation by generating further force, as is the case with marking system 100. The inventors estimate that approximately 120 in-lbs may be needed to ensure consistent marking. In one embodiment, this may be accomplished by loading a mechanical spring using a 2″ stroke 60 lb electric solenoid. Energy storage is variable and is proportional to the amount of flexing and to the mass of marker driver 120. In one embodiment, repeatable depth of marker material penetration may be accomplished using a mechanical stop that limits extension or flexing to about 1-2″.

FIG. 8B illustrates marker system 850 that uses another technique to flex elongated member 804 (which, in this illustrated embodiment, is a leaf sprint) upward. In the illustrated embodiment, actuator 126 retracts to achieve the flexing. When implantation is required, actuator 126 extends or releases its hold to rapidly spring elongated member 804 downward to implant marker material 112. In one embodiment, the potential energy alone of elongated member 804 may be enough to implant marker material 110; however, in other embodiments, marker driver 124 may assist with the implantation by generating further force, as is the case with marking system 100.

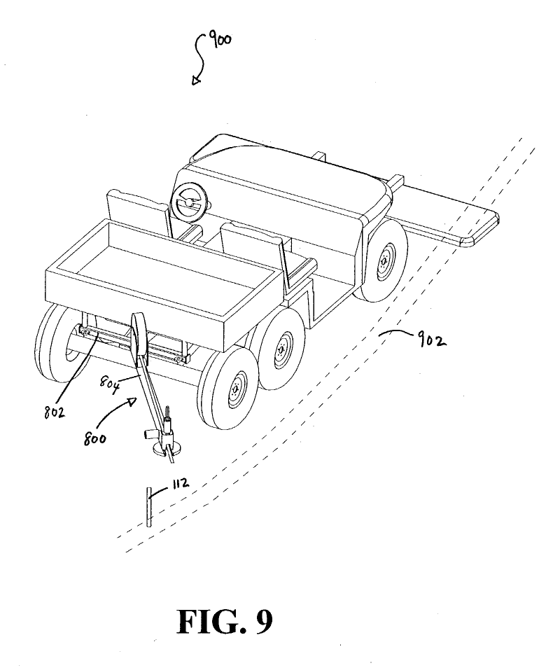

FIG. 9 is a diagram of the marking system of FIG. 8A incorporated onto a vehicle. Vehicle 900 may be of any type. In the illustrated embodiment, vehicle 900 is an All Terrain Vehicle (ATV). A marking system 800 is illustrated as being on the rear of vehicle 900. In one embodiment, connection of marking system 800 to vehicle 900 may be done via openings in frame 804. Appropriate fasteners may be inserted into those openings to attach marking system 800 to any portion of the vehicle such as the bumper (or sides). Alternatively, marking system 800 may be made integral with vehicle 900, or it may be fastened in a way to allow for quick removal in case jettison of extra equipment is required. Accordingly, vehicle 900 may be used in a wide range of applications; for instance, a buried object 902 may be readily marked, as illustrated by marker material 112 beginning to trace out the buried object's outline. One having ordinary skill in the art will recognize numerous other applications of the marking arrangement of FIG. 9.

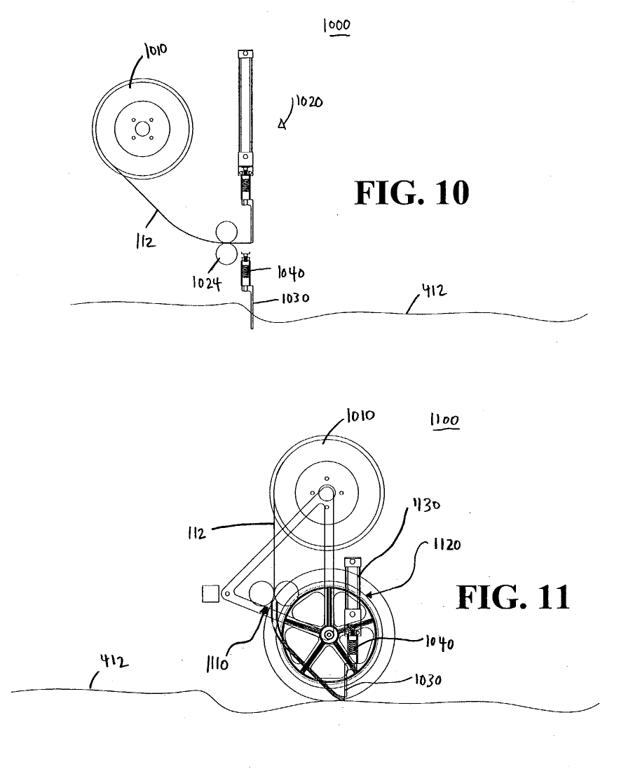

FIG. 10 is a diagram of a marking system 1000 according to embodiments of this disclosure. It should be noted that FIG. 10 illustrates the implantation process by showing the bottom portion of marking system 1000 during implantation process, with the complete marking system 1000 (in a non-implanting position) shown immediately above. Marking system 1000 includes marker holder 1010, marker advancer 124, and marker driver 1020. Marker driver 1020 includes marker ram 1030 and flexible coupling 1040.

Marker holder 1010 is analogous to marker container 110, whose description will not be repeated. Likewise, marker driver 1020 is analogous to marker driver 120, marker ram 1030 is analogous to drive member 410, and marker advancer 1024 is analogous to marker advancer 124.

Flexible coupling 1040 may be any structure suitable for providing flex so that marker ram 1030 may remain fixed relative to substrate 412 at least for a portion of the implantation process, despite motion of marking system 1000. In one embodiment, marker ram 1030 implants marker material 112 and flexible coupling 1040 bends, thereby preventing undue flexing of marker ram 1030.

In operation, marking system 1000 operates by assuming an extended position and implanting marking material 112 via marker driver 1020. During implantation, flexible coupling 1040 “absorbs” motion of the system (assuming, for instance, that it is incorporated on a moving vehicle). When implantation is complete, marking system 1000 may be retracted upwards.

FIG. 11 is a diagram of a marking system 1100 according to embodiments of this disclosure. Marking system 1100 includes marker holder 1010, marker feeder 1110, marker driving system 1120, actuator 1130, flexible coupling 1040, and marker ram 1030.

Marker holder 1010 is analogous to marker container 110, whose description will not be repeated. Likewise, marker driving system 1120 is analogous to marker driver 120, marker ram 1030 is analogous to drive member 410, and marker feeder 1110 is analogous to marker advancer 124. Flexible coupling 1040 is analogous to that described in relation to FIG. 10. Here too, flexible coupling 1040 allows marker ram 1030 to remain fixed relative to substrate 412 for at least a portion of the implantation process, despite motion of marking system 1100.

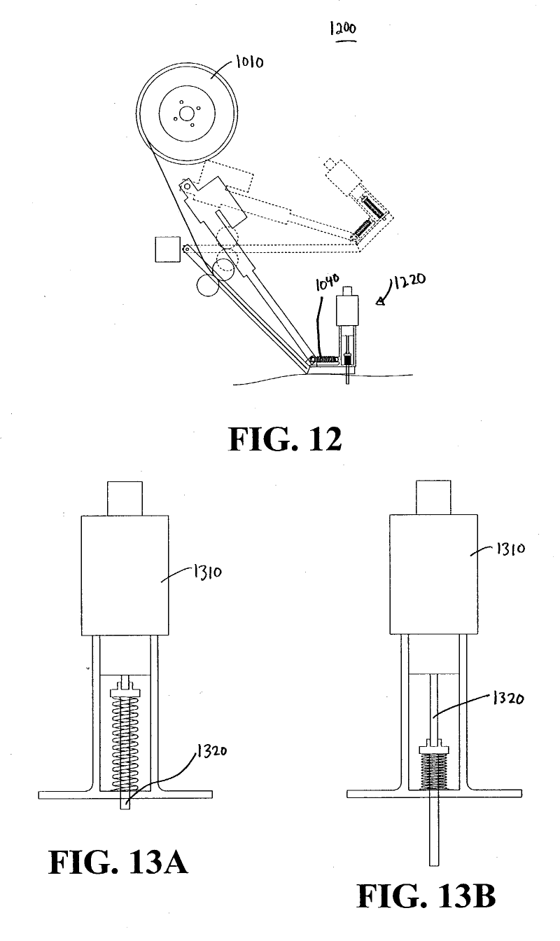

FIG. 12 is a diagram of a marking system 1200 according to embodiments of this disclosure. Marking system 1200 is similar in respects to marking system 100. However, marking system 1200 makes use flexible coupling 1040 instead of arm 406 and groove 408.

FIGS. 13A and 13B are diagrams of a marker driver according to embodiments of this disclosure. Included are solenoid driven member 1310 and drive head 1320. Such a marker driver may be used in conjunction with the embodiments discussed herein.

FIGS. 14A and 14B are diagrams of a system for forming one-sided marker material 112 having a flexible shaft material 404, according to embodiments of this disclosure. In the illustrated embodiment, flexible shaft material 404 is dispensed from spool 1412 while marker material 112 is dispensed from spool 1410. Via plate and pins 1409, flexible shaft material 404 is routed onto (or in an alternative embodiment, under) marker material 112. Marker material 112 and flexible shaft material 404 are fed through heated rollers 1404, which affix the two together, forming an integral marker material 112 having flexible shaft material 404. The system of FIGS. 14A and 14B may be incorporated into embodiment described herein. For instance, such a system may constitute marker container 110 of marker system 100 to allow for formation of suitable markers “on-the-fly.”

FIG. 15 is a diagram of a system for forming two-sided marker material 112 having a flexible shaft material 404, according to embodiments of this disclosure. In the illustrated embodiment, flexible shaft material 404 is dispensed from spool 1412 while one length of marker material 112 is dispensed from spool 1410 and another length is dispensed from spool 1510. Plate and pins 1409 route flexible shaft material 404 is routed onto marker material 112 coming from spool 1410. Marker material coming from spool 1510 is routed on flexible shaft material 404, forming a “sandwich”—two layers of marker material 112 with flexible shaft material 404 in the middle. Marker materials 112 and flexible shaft material 404 are fed through heated rollers 1404, which affix the layers together, forming an integral two-sided marker material 112 having flexible shaft material 404. The system of FIG. 15 may be incorporated into embodiment described herein. For instance, such a system may constitute marker container 110 of marker system 100 to allow for formation of suitable markers “on-the-fly.”

In embodiments of this disclosure, marker material 112 may be a plastic material (e.g., a thin PVC film), and flexible shaft material 404 may be a wire. In representative embodiments, such a wire may have a diameter of about 0.035 inches, although larger and smaller diameters may be used as well. Marker material 112 may include a reflective substance attached to at least a portion of the plastic material. The reflective substance may make the plastic material more visible against a dark background than the plastic material would be without the reflective substance.

The surface area of marker material 112 may vary depending upon twist of flexible shaft material 404 and orientation. Continuous twisted material may provide for more consistent signatures. Infrared (IR) signature coatings may be effective for providing visibility in very low light levels. Additionally, reflection of marker materials 112 may be enhanced by using highly reflective metallic coatings (e.g. metallic coated Mylar). The inventors have found that adding as little as a 100 angstroms of aluminum to marker material 112 provides high visibility. The optical gain, using aluminum, over a dark and diffuse background is significant. In different embodiments, reflective materials may be painted just prior to implantation.

Specific marking information may also be included on marking materials 112 using, for example, laser printing techniques. Information that could be placed on marking materials 112 includes but is not limited to: date, location, and other specific information concerning the mark.

In one embodiment, marker material 112 may be painted/coated with materials that fluoresce in the day or at night. There is sufficient quantity of ultraviolet (UV) radiation in the sun to increase the visible output from the fluorescence process. High-energy photons (UV) cause certain material to become excited. As the atoms de-excite, lower energy photons in the form of visible light are given off. One can choose the color from a wide variety of colors commercially available. One can also use a “black light” or certain lasers to stimulate the fluorescent material.

In another embodiment, chemiluminescence may be used to enhance visibility of marking material 112. Certain chemicals when mixed together produce visible light as is part of the chemical reaction. This is the phenomenon responsible for glow produced by “lightning bugs.” Marking material 112 may have microbeads of chemicals that mix as the material is drawn from a spool. Again, one can choose from several colors commercially available.

In another embodiment, retroreflectors may be used to enhance visibility of marking material 112. Marking material 112 may be coated with microscopic beads that act as retroreflectors, much like clothing worn by runners, cyclists, policemen, etc. Such reflectors are commercially available in several colors.

In another embodiment, retro tape may be used with marker material 112. This tape includes small “corner cubes” that redirect or return light to its source. Ordinary flashlights, spotlights, lasers, etc could activate such a passive system. This system could be used to mitigate some obscurants such as light fog, light smoke, or the like.

In another embodiment, exothermic reactions may be used to enhance visibility of marking material 112. Certain chemicals, when mixed, give off heat just as others give off light as discussed above. As marker material 112 is deployed from its dispenser, chemicals may be combined to generate heat that would fall into the long wavelength part of the electro-magnetic spectrum. Such heat could then be detected using equipment such as but not limited to a FLIR (Forward Looking InfraRed) device.

In this document (including the claims), the terms “comprise” (and any form of comprise, such as “comprises” and “comprising”), “have” (and any form of have, such as “has” and “having”), and “include” (and any form of include, such as “includes” and “including”) are open-ended linking verbs. Thus, a system, method, or apparatus “comprising” elements (a), (b), and (c) possesses those steps but is not limited to possessing only those steps. The terms “a” and “an” are defined as one or more than one unless the this disclosure explicitly requires otherwise. The term “coupled” is defined as connected, although not necessarily directly, and not necessarily mechanically.

With the benefit of this disclosure, those having ordinary skill in the art will comprehend that techniques claimed herein and described above may be modified and applied to a number of additional, different applications, achieving the same or a similar result. For example, one will recognize that components of different illustrated marking systems may be interchanged with components of other systems. Further, it will be recognized that any of the systems may be incorporated onto vehicles or other objects. The claims cover all modifications that fall within the scope and spirit of this disclosure.

We claim:

1. A marking system comprising:
(a) a marker container configured to contain marker material having flexible shaft material;
(b) a marker cutter coupled to the marker container; and
(c) a marker driver coupled to the marker cutter.

2. The marking system of claim 1, the marker container being configured to join the marker material and the flexible shaft material.

3. The marking system of claim 1, further comprising:
(d) a frame to which the marker container, the marker cutter, and the marker driver are coupled.

4. The marking system of claim 1, further comprising:
(d) a marker advancer coupled to the marker container.

5. The marking system of claim 4, further comprising:
(e) a frame to which the marker container, the marker advancer, the marker cutter, and the marker driver are coupled.

6. The marking system of claim 4, further comprising:
(e) a control system configured to automate operation of the marker advancer, the marker cutter, and the marker driver.

7. The marking system of claim 4, in which the marker advancer includes a motorized wheel configured to contact and advance marker material.

8. The marking system of claim 1, in which the marker container includes a spool around which the marker material can be wound.

9. The marking system of claim 8, in which the spool includes marker material wound around the spool, the marker material including a flexible shaft.

10. The marking system of claim 1, in which the marker cutter includes a hinged cutting member.

11. The marking system of claim 1, in which the marker driver includes a solenoid-driven member.

12. The marking system of claim 1, further comprising:
(d) an actuator coupled to the marker driver that, when actuated, causes the marker driver to transition from a retracted position to an extended position.

13. The marking system of claim 12, further comprising:
(e) a frame to which the actuator is hinged at a first location; and
(f) an elongated marker feeder coupled to the marker driver and hinged to the frame at a second location, the actuator being hinged to the elongated marker feeder at a third location.

14. The marking system of claim 1, further comprising:
(d) a frame to which the marker container, the marker cutter, and the marker driver are coupled;
(e) a marker advancer coupled to the frame; and
(f) an elongated member hinged to the frame to allow the elongated member to move from side to side, the marker driver being coupled to an end of the elongated member.

15. A marking system comprising:
(a) a frame;
(b) a marker container coupled to the frame, the marker container configured to contain marker material;
(c) an actuator hinged to the frame at a first location;
(d) a marker feeder hinged to the frame at a second location, the marker feeder being hinged to the actuator at a third location;
(e) a marker advancer coupled to the marker feeder;
(f) a marker cutter coupled to the marker feeder; and
(g) a marker driver coupled to an end of the marker feeder.

16. The marking system of claim 15, in which the marker driver includes a solenoid-driver member coupled to a foot.

17. The marking system of claim 16, in which the foot and marker driver are configured to remained fixed despite movement by the marking system.

18. The marking system of claim 15, further comprising:
(h) a control system configured to automate operation of the actuator, the marker advancer, the marker cutter, and the marker driver.

19. The marking system of claim 18, in which the control system includes a load sensor coupled to the actuator configured to send a signal in response to the marker driver contacting a substrate.

20. The marking system of claim 15, in which the marker advancer includes a motorized wheel configured to contact and advance marker material.

21. The marking system of claim 15, in which the marker container includes a spool around which the marker material can be wound.

22. The marking system of claim 21, in which the spool includes marker material wound around the spool, the marker material including a flexible shaft.

23. The marking system of claim 22, the marker container being configured to join the marker material and material comprising the flexible shaft.

24. The marking system of claim 15, in which the marker cutter includes a hinged cutting member.

25. A marking method comprising:
(a) directing a vehicle along a substrate, the vehicle including a marking system;
(b) inserting a marker having a flexible shaft into the substrate using the marking system; and
(c) bending the marker during the inserting such that a bent portion of the flexible shaft is implanted into the substrate.

26. The marking method of claim 25, further comprising:
(d) cutting the marker prior to the inserting.

27. The marking method of claim 25, in which the inserting includes inserting the marker into the substrate with a member driven by a solenoid.

28. An apparatus for marking a substrate, the apparatus comprising:
(a) a wire;
(b) a plastic material attached to the wire; and
(c) a reflective substance attached to at least a portion of the plastic material, the reflective substance making the plastic material more visible against a dark background than the plastic material would be without the reflective substance;
(d) where the apparatus, or a section of the apparatus, is configured for implantation into the substrate.

29. The apparatus of claim 28, further comprising:
(e) a spool around which the wire is wrapped.

30. The apparatus of claim 28, where the reflective substance includes aluminum.

31. The apparatus of claim 28, where the wire comprises copper or steel wire.

32. The apparatus of claim 31, where the wire has a diameter of at least 0.035 inches.

33. The apparatus of claim 28, where the plastic material includes indicia.

34. The apparatus of claim 33, where the indicia includes a date or location.

35. A marking system comprising:
(a) a marker holder; and
(b) a marker driver in operative relation with the marker holder, the marker driver comprising:
(i) a marker ram; and
(ii) a flexible coupling coupled to the marker ram.

36. A marking system comprising:
(a) a marker holder;
(b) a marker feeder in operative relation with the marker holder; and
(c) a marker driving system in operative relation with the marker feeder, the marker driver system comprising:
(i) an actuator; and
(ii) a marker ram coupled to the actuator by a flexible coupling.
